(19) United States
(12) Patent Application Publication
(10) Pub. No.: US 2026/0039628 A1
(43) Pub. Date: Feb. 5, 2026

(54) NETWORK-PACKET FILTERING SYSTEM AND METHOD

(71) Applicant: Nuvoton Technology Corporation, Hsinchu Science Park (TW)

(72) Inventor: Yeh-Hsing HOU, Kaohsiung City (TW)

(21) Appl. No.: 19/247,544

(22) Filed: Jun. 24, 2025

(30) Foreign Application Priority Data
Aug. 5, 2024 (TW) 113129143

(51) Int. Cl. H04L 9/40

(52) U.S. Cl. CPC H04L 63/0236

(57) ABSTRACT

A network-packet filtering system is provided. The system includes one or more end hosts and a network-packet filtering device communicable with the end hosts and an external network. Each end host obtains its host-performance vector by executing a first neural network model based on its system-performance information. The network-packet filtering device determines whether to drop a packet from the external network or to pass the packet by executing a second neural network model based on the host-performance vectors and the packet.

### CROSS REFERENCE TO RELATED APPLICATIONS

This application claims priority of Taiwan Patent Application No. 113129143, filed on Aug. 5, 2024, the entirety of which is incorporated by reference herein.

### BACKGROUND OF THE INVENTION

### Field of the Invention

The present invention relates to information technology and network management, and, in particular, it relates to a network-packet filtering system and a method thereof.

### Description of the Related Art

Currently, network packets are mainly filtered through firewalls. A firewall is a network security device or software that is installed between an internal network (e.g., an enterprise network, cloud network, IoT network) and an external network (e.g., the Internet). It identifies and controls packet ingress and egress in the internal network, so that it can protect the internal network from unauthorized access and potential threats.

One example is the enterprise network, in which a network administrator sets static rules in the firewall. When the firewall receives a network packet from the external network, it compares the packet header information (e.g., source address, destination address, protocol, port, etc.) with the static rules. Moreover, it executes actions that correspond to the matching static rules, e.g., discarding packets or allowing packets to pass.

However, when a large-scale network attack occurs, the hosts on the internal network may still be attacked by large-scale traffic even if the firewall filters certain types of packets. This can cause an overload, or even an exhaustion of resources.

In a Distributed Denial of Service (DDoS) attack, for example, a large number of devices distributed in different locations (called botnets) are used to send a large number of requests. This causes the target system to exceed its processing capacity and makes it hard to function properly. Since the locations of the attackers in a DDoS attack may come from all directions and cannot be predicted in advance, DDoS attacks can't easily be identified and blocked by firewalls. Therefore, even if a firewall is set up, the host in the internal network may still receive attack packets from the external network when overloaded. This causes the resources of the attacked host to become exhausted, or even to crash.

Therefore, a network-packet filtering system and method that can solve the aforementioned problems is needed.

### BRIEF SUMMARY OF THE INVENTION

An embodiment of the present invention provides a network-packet filtering system. The network-packet filtering system comprises: one or more end hosts and a network-packet filtering device which is communicable to the one or more end hosts and an external network. Each of the one or more end hosts executes a first neural network model to obtain a host-performance vector based on system-performance information of each of the one or more end host. The network-packet filtering device is configured to execute a second neural network model to determine, based on a packet from the external network and the host-performance vectors from the one or more end hosts, whether to allow the packet to pass or to discard the packet.

An embodiment of the present invention provides a network-packet filtering method. The network-packet filtering method is applied to a computer system. The computer system comprises one or more end hosts and a network-packet filtering device which is communicable to the one or more end hosts and communicable to an external network. The network-packet filtering method comprises: by each of the one or more end hosts, executing a first neural network model to obtain a host-performance vector based on system-performance information of each of the one or more end hosts. The network-packet filtering method further comprises: by the network-packet filtering device, executing a second neural network model to determine, based on a packet from the external network and the host-performance vectors from the end hosts, whether to allow the packet to pass or to discard the packet.

The network-packet filtering system and method provided by the present disclosure can block packets which may increase the system load. This avoids system overload and improves the security and stability of the system. Specifically, the network-packet filtering system may determine whether a packet will burden a system (internal network) or a single host, and blocks the packet that may increase the load on the system or the single host when the system or the single host is overloaded.

### BRIEF DESCRIPTION OF THE DRAWINGS

The present invention can be more fully understood by reading the subsequent detailed description and examples with references made to the accompanying drawings. Furthermore, it should be understood that, in the flowcharts of the present disclosure, the execution order of each block may be changed, and/or some blocks may be changed, deleted or combined.

FIG. 1 is a system architecture diagram of a network-packet filtering system according to an embodiment of the present invention.

FIG. 2 is a flow chart of a network-packet filtering method according to an embodiment of the present invention.

FIG. 3A is a flow chart illustrating details about a step of the network-packet filtering method in FIG. 2 according to an embodiment of the present invention.

FIG. 3B is a block diagram of an end host implementing the steps shown in FIG. 3A.

FIG. 4A is a flow chart showing details about a step of the network-packet filtering method in FIG. 2 according to an embodiment of the present invention.

FIG. 4B is a block diagram of the network-packet filtering device implementing the steps shown in FIG. 4A.

FIG. 5 is a flow chart of the pre-processing operation according to an embodiment of the present invention.

FIG. 6 is a flow chart of a network-packet filtering method according to an embodiment of the present invention.

### DETAILED DESCRIPTION OF THE INVENTION

The following description is made for the purpose of illustrating the general principles of the disclosure and should not be taken in a limiting sense. The scope of the disclosure is best determined by reference to the appended claims.

In each of the below embodiments, the same or similar elements or components will be represented by the same reference numerals.

The serial numbers in this description and the scope of the patent application, such as “first”, “second”, etc., are only for convenience of explanation, and there is no sequential relationship between them.

The description of the embodiments of the device or system in this disclosure also applies to the embodiments of the method, and vice versa.

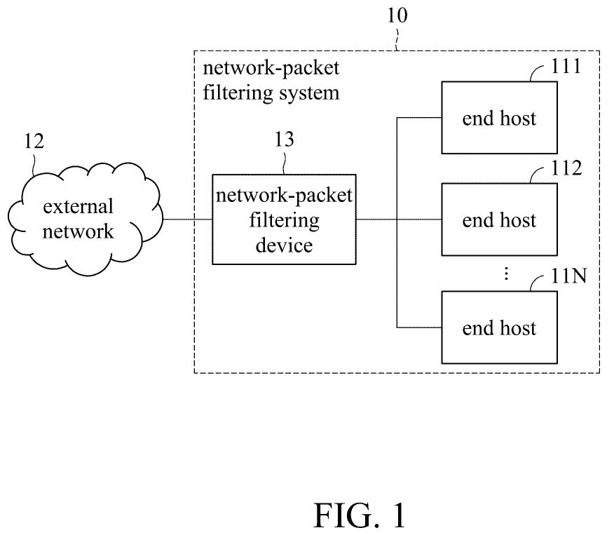

FIG. 1 is a system architecture diagram of a network-packet filtering system 10 according to an embodiment of the present invention. As shown in FIG. 1, the network-packet filtering system 10 may include a network-packet filtering device 13 and end hosts 111, 112˜11N. The network-packet filtering device 13 and the end hosts 111, 112˜11N are communicable with each other. The network-packet filtering system 10 in the example of FIG. 1 includes multiple end hosts 111˜11N. However, it should be noted that the present disclosure does not limit the number of end hosts in the network-packet filtering system 10. In some embodiments, the network-packet filtering system 10 may include only one end host.

The end hosts 111˜11N may be any computer system with computing capabilities, such as a personal computer (e.g., a desktop computer or a notebook computer), a server computer, a bridge IC (BIC), or a mobile device (e.g., a tablet computer or a smart phone). The present disclosure is not limited thereto.

The end host 111˜11N includes a processing unit and a storage unit. The processing unit may include any one or more general-purpose or special-purpose processors and combinations thereof for executing instructions, such as a central processing unit (CPU) and/or a graphics processing unit (GPU). The storage unit may be any type of device that includes non-volatile memory (e.g., read only memory, electrically-erasable programmable read-only memory (EEPROM), flash memory, non-volatile random access memory (NVRAM)), such as hard disk drives (HDD), solid state drives (SSD) or optical disks. The present disclosure is not limited thereto.

The network-packet filtering device 13 can be any computer system with computing capabilities, such as a personal computer (e.g., a desktop computer or a notebook computer), a server computer, a baseboard management controller (BMC), a router, or a mobile device (e.g., a tablet computer or a smart phone). The present disclosure is not limited thereto. As the aforementioned end hosts 111˜11N, the network-packet filtering device 13 may also include a processing unit and a storage unit.

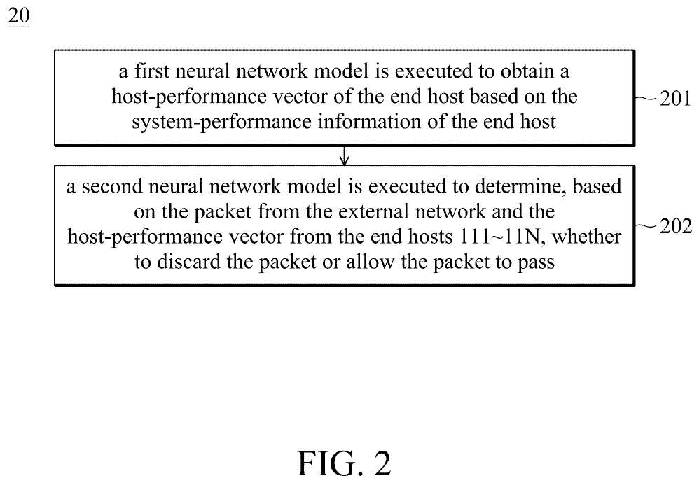

In various embodiments, the network-packet filtering system 10 implements a network-packet filtering method. The network-packet filtering method is described below with reference to FIG. 2.

FIG. 2 is a flow chart of a network-packet filtering method 20 according to an embodiment of the present invention. As shown in FIG. 2, the network-packet filtering method 20 comprises a step 201 and a step 202. Step 201 is performed by the end host 111˜11N. Step 202 is performed by the network-packet filtering device 13.

In the step 201, each of the end hosts 111˜11N obtains its own host-performance vector based on its own system-performance information by executing a first neural network model. The first neural network model acts as a feature extractor in the step 201. The host-performance vector represents the features extracted by the first neural network model from the system-performance information in the form of a vector.

In various embodiments, the storage unit of the end host stores one or more programs corresponding to the step 201. Program is a sequence or set of instructions for a computer system to execute. In various embodiments, the program may be written in any one or more programming languages, such as Java, C, C#, C++, Python, etc. The present disclosure is not limited thereto. When the processing unit of the end host loads the program from the storage unit, the step 201 may be implemented.

In step 202, the network-packet filtering device 13 executes a second neural network model to determine whether to discard a packet from the external network 12 or allow the packet to pass based on the packet and the host-performance vector from the end hosts 111˜11N.

In various embodiments, the storage unit of the network-packet filtering device 13 stores one or more programs corresponding to step 202. When the processing unit loads the program from the storage unit, step 202 may be implemented.

The external network 12 is a network outside the internal network where the network-packet filtering device 13 and the end hosts 111˜11N are located, such as the Internet or the internal network of other enterprises or organizations.

In one embodiment, the network-packet filtering system 10 may further include a router or a switch. The router or switch is connected between the network-packet filtering device 13 and the end hosts 111˜11N to route or forward packets passing through the network-packet filtering device 13 to the target end host. In another embodiment, the network-packet filtering device 13 may have a routing or forwarding function, to route or forward the allowed-to-pass packets to the target end host.

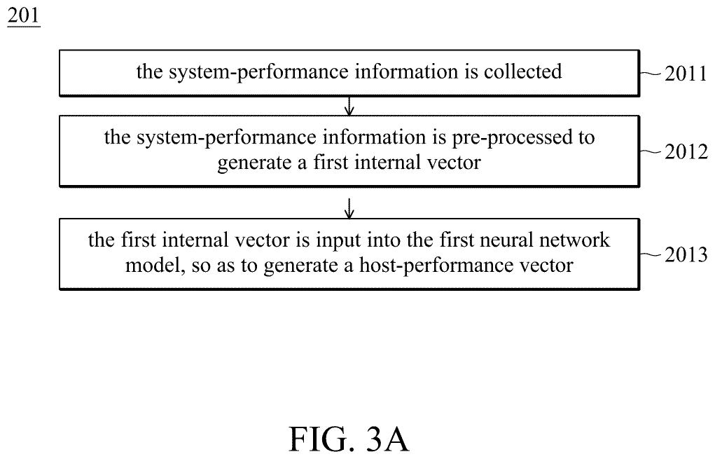

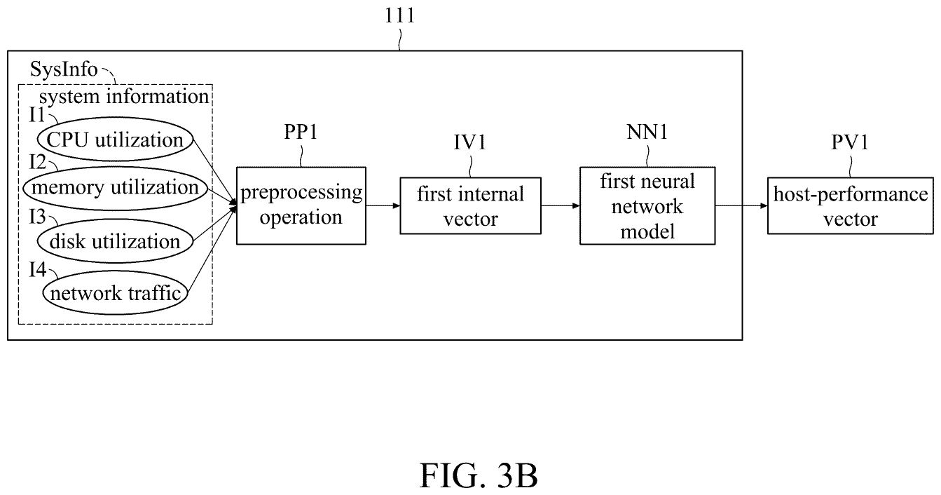

FIG. 3A is a flow chart illustrating details about the step 201 of the network-packet filtering method 20 in FIG. 2 according to an embodiment of the present invention. Correspondingly, FIG. 3B is a block diagram of the end host 111 implementing the steps shown in FIG. 3A in this embodiment. Please refer to FIGS. 3A and 3B and the corresponding description below to clearly understand this embodiment.

In a step 2011, the end host 111 collects the system-performance information SysInfo. In one embodiment, as shown in FIG. 3B, the system-performance information SysInfo may include CPU utilization I1, memory utilization I2, disk utilization I3, and network traffic I4. The present disclosure is not limited thereto. In other embodiments, the system-performance information SysInfo may further include information related to system performance, e.g., CPU speed, CPU temperature, number of processes, number of threads, input/output operations per second (IOPS) of the disk, power status and/or network latency.

The system-performance information SysInfo may be obtained by calling the application programming interface (API), library and/or task manager, system monitor or resource monitor provided by the operating system. Take the Linux operating system as an example. By opening and reading the files ‘/proc/stat’, ‘/proc/meminfo’, ‘/proc/diskstats’, and ‘/proc/net/dev’, performance information related to CPU, memory, hard disk, and network may be obtained. Take Windows operating system as an example. The performance information may be obtained through a task manager.

In a step 2012, the end host 111 pre-processes the system-performance information SysInfo, to generate a first internal vector IV1. In the example of FIG. 3B, the end host 111 performs a pre-processing operation PP1 on the CPU utilization I1, the memory utilization I2, the disk utilization I3, and the network traffic I4. Next, the end host 111 may obtain the first internal vector IV1. In an implementation, the first internal vector IV1 is a one-dimensional vector obtained by merging the CPU utilization I1, the memory utilization I2, the disk utilization I3, and the network traffic I4 after the pre-processing operation PP1.

The pre-processing operation PP1 may include filling missing data, feature scaling (e.g., data normalization, data standardization, etc.), one-hot encoding (OHE), etc. The present disclosure is not limited thereto.

In a step 2013, the end host 111 inputs the first internal vector IV1 to the first neural network model NN1, to generate a host-performance vector PV1.

In one embodiment, the first neural network model NN1 is a deep neural network. The input of the first neural network model NN1 is the first internal vector IV1. The output of the first neural network model NN1 is the host-performance vector PV1. It should be understood that the value of the host-performance vector PV1 is different from the value of the first internal vector IV1. The value of the host-performance vector PV1 is calculated by the first neural network model NN1 based on the value of the first internal vector IV1 and is usually hard for humans to understand. In addition, the length of the host-performance vector PV1 is usually shorter than the length of the first internal vector IV1. In other words, the first neural network model NN1 compresses the first internal vector IV1. This can effectively avoid leakage of information (e.g., system-performance information) and reduce transmission volume during the end hosts 111˜11N transmitting the host-performance vector PV1.

In one embodiment, the first neural network model NN1 uses an autoencoder to perform unsupervised learning. Therefore, no label data is required. The autoencoder includes an encoder and a decoder. During the learning process of the autoencoder, the encoder generates codes based on the input. The decoder reconstructs the input based on the codes. The autoencoder calculates the loss based on the input and the reconstructed input and readjusts the model parameters. Then, the aforementioned steps are repeated until the loss is reduced to a certain level. When the loss is reduced to a certain level, the training is considered finished. Then, the encoder of the trained autoencoder can be used as the first neural network model NN1.

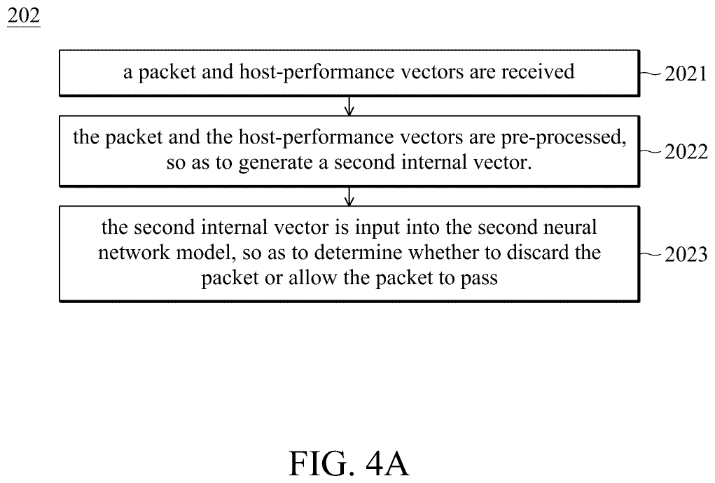

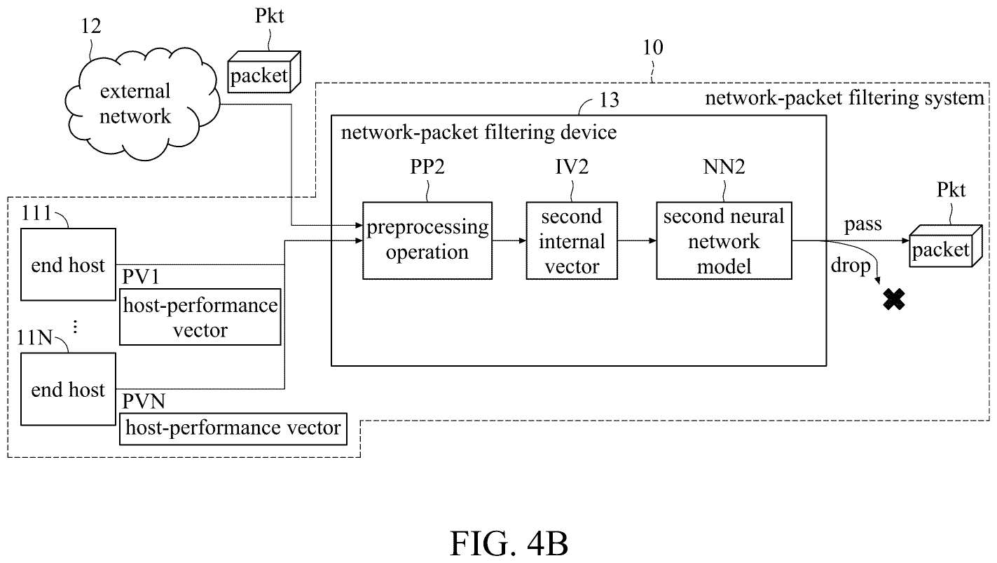

FIG. 4A is a flow chart showing details about step 202 of the network-packet filtering method 20 in FIG. 2 according to an embodiment of the present invention. Correspondingly, FIG. 4B is a block diagram of the network-packet filtering device 13 implementing the steps shown in FIG. 4A in this embodiment. Please refer to FIGS. 4A and 4B and the corresponding description below to clearly understand this embodiment.

In a step 2021, the network-packet filtering device 13 receives a packet Pkt and host-performance vectors PV1˜PVN. As shown in FIG. 4B, the network-packet filtering device 13 receives the host-performance vectors PV1˜PVN from the end hosts 111˜11N, and receives the packet Pkt from the external network 12.

In a step 2022, the network-packet filtering device 13 pre-processes the packet Pkt and the host-performance vectors PV1˜PVN, to generate a second internal vector IV2. As shown in FIG. 4B, the network-packet filtering device 13 performs a pre-processing operation PP2 on the packet Pkt and the host-performance vectors PV1˜PVN. Afterwards, the network-packet filtering device 13 can obtain the second internal vector IV2.

In a step 2023, the network-packet filtering device 13 inputs the second internal vector IV2 to the second neural network model NN2, to determine whether to discard the packet Pkt or allow the packet Pkt to pass. The second neural network model is used as a classifier in step 2023. Specifically, the second neural network model makes inferences based on model parameters obtained through its training, and maps the input second internal vector IV2 to a determination result of discarding the packet Pkt or allowing the packet Pkt to pass.

The pre-processing operation PP2 may include filling missing data, feature scaling (e.g., data normalization, data standardization, etc.), one-hot encoding (OHE), etc. The present disclosure is not limited thereto.

In one embodiment of the present invention, the pre-processing operation PP2 further includes merging the packets Pkt and all received host-performance vectors into the second internal vector IV2.

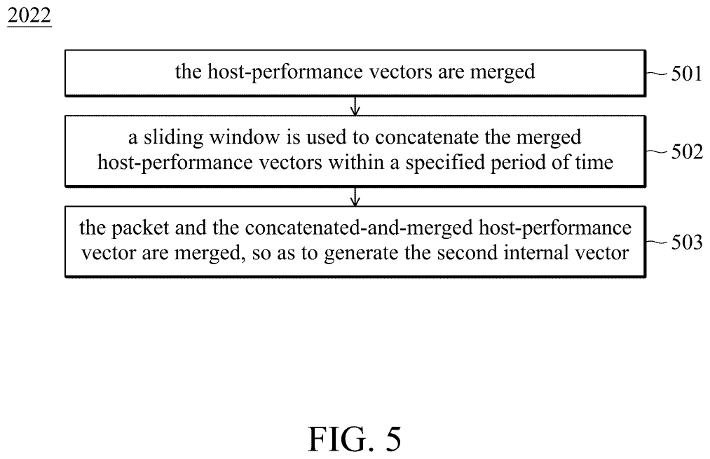

FIG. 5 is a flow chart of the pre-processing operation PP2 according to another embodiment of the present invention. In a step 501, the network-packet filtering device 13 merges all received host-performance vectors. In a step 502, the network-packet filtering device 13 uses a sliding window to concatenate the merged host-performance vectors within a specified period of time. In step 503, when the packet Pkt is received, the network-packet filtering device 13 further merges the packet Pkt and the concatenated-and-merged host-performance vector into the second internal vector.

In one embodiment, the second neural network model NN2 is a recurrent neural network (RNN). Recurrent neural network is a neural network designed for sequential data. Unlike traditional feedforward neural networks (FNN), RNN has an internal memory mechanism that can refer to the previously retained information at each inference. This allows the neural network to remember the relation between the sequential data. In a further embodiment, the second neural network model NN2 is a long short-term memory (LSTM) model.

The output of the second neural network model NN2 is a control strategy for the packet Pkt. For example, when the control strategy is 0, the network-packet filtering device 13 is indicated to drop the packet. Therefore, the network-packet filtering device 13 will not output the packet. For another example, when the control strategy is 1, the network-packet filtering device 13 is indicated to allow the packet to pass. Therefore, the packet can enter the internal network.

In one embodiment, the sequential data input to the second neural network model NN2 includes the second internal vector IV2, which is generated based on the packet Pkt, and the information retained by the previous inference, which is associated with the previous second internal vector. In other words, the input of the second neural network model NN2 is the current second internal vector IV2 and the information associated with the previous second internal vector.

Therefore, the second neural network model NN2 can observe the trend of changes in the overall system load/performance and its relation with the packet type based on the previous and current second internal vectors, to determine control strategies for the current packet or future packets of this type. For example, when the second neural network model NN2 observes that the system load has an increasing or decreasing trend, the network-packet filtering device 13 is indicated to restrict or allow packet reception. For example, when the second neural network model NN2 observes that the system performance decreases each time a certain type of packet is received, the network-packet filtering device 13 is indicated to directly block the packet of that type.

In one embodiment, the second neural network model NN2 may perform supervised learning using the training data which consists of the network intrusion detection dataset, the host-performance vectors output by the first neural network model NN1, and the label values manually labeled according to the network intrusion detection dataset and the system information corresponding to the host-performance vector. The network intrusion detection dataset can be obtained from the open dataset NSL-KDD, or packet records collected by packet trace technology during tracking network attacks. However, the disclosure is not limited thereto.

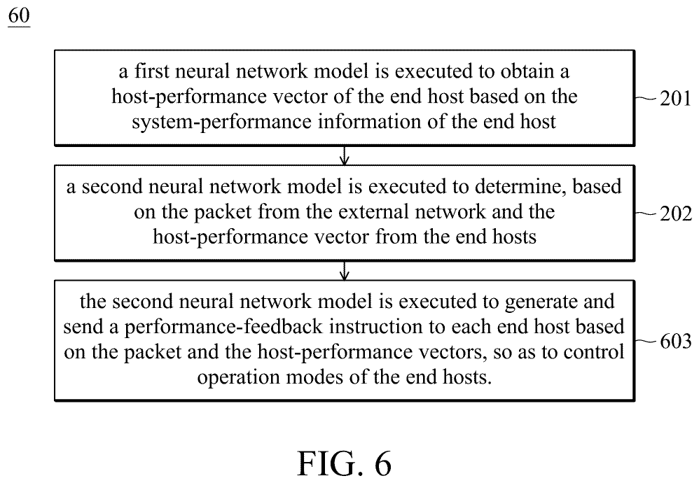

FIG. 6 is a flow chart of a network-packet filtering method 60 according to an embodiment of the present invention. The network-packet filtering method 60 is similar to the network-packet filtering method 20. The network-packet filtering method 60 can also be applied to the network-packet filtering system 10. However, compared with the network-packet filtering method 20, the network-packet filtering method 60 further includes step 603.

Similarly, in the step 201, the end hosts 111˜11N execute their respective first neural network models and obtain their respective host-performance vectors based on their respective system-performance information. In step 202, the network-packet filtering device 13 executes a second neural network model to determine whether to discard the packet or allow the packet to pass based on the packet from the external network 12 and the host-performance vectors from the end hosts 111˜11N.

Then, in step 603, the network-packet filtering device 13 generates and sends a performance-feedback instruction to each end host based on the packet and the host-performance vectors by executing the second neural network model NN2, to control the operation mode of the end hosts.

In one embodiment, the performance-feedback instruction may include a performance tuning parameter as a suggestion provided by the network-packet filtering device 13 to the end host for adjusting the load. When receiving the performance-feedback instruction, the end host refers to the performance tuning parameter in the performance-feedback instruction to adjust its own operation mode.

In one embodiment, when the performance tuning parameter is 0, the end host is indicated to lower its operation mode by one level. When the performance tuning parameter is 1, the end host is indicated to increase its operation mode by one level.

For example, the end hosts 111˜11N have three operation modes from high level to low level: high-efficiency, normal and low-power mode. When the second neural network NN2 of the network-packet filtering device 13 determines the system to be overloaded, the network-packet filtering device 13 may send performance-feedback instructions with performance tuning parameters of 0 to the end hosts 111˜11N. These performance-feedback instructions may instruct the end hosts 111˜11N to switch from high-efficiency mode to normal mode or from normal mode to low-power mode. The end host with low-power mode remains unchanged as the low-power mode is already the lowest level.

In another example, when the performance tuning parameter is +1, the end host is indicated to increase its operation mode by one level. When the performance tuning parameter is +2, the end host is indicated to increase its operation mode by two levels. When the performance tuning parameter is −1, the end host is indicated to lower its operation mode by one level. When the performance tuning parameter is −2, the end host is indicated to lower its operation mode by two levels.

For example, when the second neural network NN2 of the network-packet filtering device 13 determines the system to be in a low load state, the network-packet filtering device 13 may send performance-feedback instructions with performance tuning parameters of 0, 0, +2 respectively to the end hosts 111˜113 whose are respectively in high-efficiency, normal, and low-power mode. These performance-feedback instructions may instruct the end hosts 111 and 112 not to change their operation modes, and instruct the end host 113 to switch from the low-power mode to the high-efficiency mode.

The network-packet filtering system and method provided by the present disclosure can block packets which may increase the system load. This avoids system overload and improves the security and stability of the system. Specifically, the network-packet filtering system may determine whether a packet will burden a system (internal network) or a single host, and blocks the packet that may increase the load on the system or the single host when the system or the single host is overloaded.

The above paragraphs are described in various ways. Obviously, the teachings of this article can be implemented in a variety of ways, and any specific architecture or functionality disclosed in the examples is only a representative situation. Based on the teachings of this article, it should be understood in the art that each aspect disclosed in this article can be implemented independently, or two or more aspects can be combined and implemented.

Although the present disclosure has been described using embodiments as above, they are not intended to limit the present disclosure. A person skilled in the art may make some modifications without departing from the spirit and scope of the present disclosure. Therefore, the protection scope of the disclosure shall be determined by the appended patent application scope.

What is claimed is:

1. A network-packet filtering system, comprising:
one or more end hosts, wherein each of the one or more end hosts executes a first neural network model to obtain a host-performance vector based on system-performance information of each of the one or more end hosts; and
a network-packet filtering device, communicable to the one or more end hosts and an external network, and configured to execute a second neural network model to determine, based on a packet from the external network and the host-performance vectors from the one or more end hosts, whether to allow the packet to pass or to discard the packet.

2. The network-packet filtering system as claimed in claim 1, wherein the network-packet filtering device further:
receives the packet and the host-performance vectors;
preprocesses the packet and the host-performance vectors, to generate a second internal vector; and
inputs the second internal vector into the second neural network model, to determine whether to allow the packet to pass or to discard the packet.

3. The network-packet filtering system as claimed in claim 2, wherein the operation of the network-packet filtering device preprocessing the packet and the host-performance vectors comprises:
merging the host-performance vectors;
using a sliding window to concatenate the merged host-performance vectors within a specified time period; and
merging the packet and the concatenated-and-merged host-performance vectors, so as to generate the second internal vector.

4. The network-packet filtering system as claimed in claim 1, wherein the second neural network model is a recurrent neural network (RNN).

5. The network-packet filtering system as claimed in claim 1, wherein the network-packet filtering device further executes the second neural network model to generate and send, based on the packet and the host-performance vectors, a performance-feedback instruction to the one or more end hosts, to control operation modes of the one or more end hosts.

6. A network-packet filtering method, applied to a computer system, wherein the computer system comprises one or more end hosts and a network-packet filtering device which is communicable to the one or more end hosts and communicable to an external network, wherein the network-packet filtering method comprises the following steps:
executing a first neural network model by each of the one or more end hosts to obtain a host-performance vector based on system-performance information of each of the one or more end hosts; and
executing a second neural network model by the network-packet filtering device to determine, based on a packet from the external network and the host-performance vectors from the end hosts, whether to allow the packet to pass or to discard the packet.

7. The network-packet filtering method as claimed in claim 6, further comprising:
receiving the packet and the host-performance vectors by the network-packet filtering device;
preprocessing the packet and the host-performance vectors by the network-packet filtering device, to generate a second internal vector; and
inputting the second internal vector into the second neural network model by the network-packet filtering device, to determine whether to allow the packet to pass or to discard the packet.

8. The network-packet filtering method as claimed in claim 7, wherein the step of preprocessing the packet and the host-performance vectors comprises:
merging the host-performance vectors;
using a sliding window to concatenate the merged host-performance vectors within a specified time period; and
merging the packet and the concatenated-and-merged host-performance vectors, to generate the second internal vector.

9. The network-packet filtering method as claimed in claim 6, wherein the second neural network model is a recurrent neural network (RNN).

10. The network-packet filtering method as claimed in claim 6, further comprising:
executing the second neural network model by the network-packet filtering device to generate and send, based on the packet and the host-performance vectors, a performance-feedback instruction to each of the end hosts, so as to control operation modes of the end hosts.
